(19) United States
(12) Patent Application Publication
(10) Pub. No.: US 2007/0114411 A1
(43) Pub. Date: May 24, 2007

(54) Apparatus for generating corona discharges

(76) Inventor: Keping Yan, Geldrop (NL)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/573,923

(22) PCT Filed: Sep. 24, 2004
(86) PCT No.: PCT/NL04/00664

§ 371 Date: Nov. 8, 2006

(30) Foreign Application Priority Data
Sep. 30, 2003 (NL) 1024408

(51) Int. Cl. H01T 19/04

(52) U.S. Cl. 250/324

(57) ABSTRACT

The invention relates to an apparatus for generating corona discharges, comprising a corona discharge space (2); a discharge electrode disposed in the corona discharge space; as well as a high voltage source (3, 4), an output of which is connected to the discharge electrode. The object of the present invention is to provide an apparatus for generating corona discharges as referred to in the introduction, which on the one hand is of less complex construction, but which is furthermore functionally built up of components that make it possible to use the apparatus with high pulsed power levels as well, and the apparatus is to that end characterized in that at least one element having diode functionality (5) is connected between the high voltage source and the discharge electrode, which element delivers a DC high voltage component comprising a superposed AC high voltage component on the discharge electrode.

The invention relates to an apparatus for generating corona discharges, comprising

a corona discharge space;

a discharge electrode disposed in the corona discharge space; as well as

a high voltage source, an output of which is connected to the discharge electrode.

Such an apparatus is for example disclosed in International patent application WO 97/18899. Said publication discloses a specific application for treating gases or liquids, in which use is made of pulsed corona discharges. Pulses of a few dozen kV are converted into very rapidly rising pulses from the high voltage source and supplied to the corona discharge space via the discharge electrode.

To obtain an adequate, controlled generation of the pulsed corona discharges in the corona discharge space. WO 97/18899 employs so-called spark gaps built up of heavy electrodes of complex construction, which are costly, therefore. Said complex construction is necessary, on the one hand because of the high voltage signals that are used, but also in order to ensure a relatively long life span. In addition to the fact that the life span of a spark gap is usually limited, the usability of the apparatus as referred to in the introduction is also limited by the maximally attainable pulsed power that the high voltage source can supply to the corona discharge space.

The object of the present invention is therefore to provide an apparatus for generating corona discharges as referred to in the introduction, which on the one hand is of less complex construction, but which is furthermore functionally built up of components that make it possible to use the apparatus with high power levels as well.

According to the invention, the apparatus is to that end characterized in that at least one element having diode functionality is connected between the high voltage source and the discharge electrode, which element delivers a DC high voltage component comprising a superposed AC high voltage component on the discharge electrode. These features not only enable a strongly simplified construction of the apparatus according to the invention, but they also make it possible to use the apparatus for so-called positive “streamer” corona discharges.

Furthermore, the apparatus can be built up of simple components, which on the one hand render the apparatus less complex and costly, but which in addition have a long life span and furthermore make it possible to subject the apparatus to higher power levels.

In a specific embodiment, by means of which a simple, reliable control of the corona discharge space is effected, the element having diode functionality is a semiconductor, which is configured as a rectifier, a transistor, a diode or a thyristor, for example.

In a special embodiment, the element having diode functionality is configured as a single-phase rectifier, but in other embodiments it may be configured as a bridge rectifier.

More specifically, the DC high voltage is 10-60 kV, more in particular 5-35 kV, whilst the frequency of the AC high voltage is 0.1-100 kHz, more in particular 5-30 kHz.

In a specific embodiment of the apparatus according to the invention, the discharge electrode is an elongated body having several projecting edges or cams. Because of these features, a correct discharge moment of the corona discharges, in particular of positive “streamer” corona discharges, is ensured.

In yet another embodiment, the corona discharge space is according to the invention built up of at least two parallel, electrically earthed plates, between which plates the discharge electrode extends in parallel relationship therewith.

More in particular, a specific embodiment of the apparatus according to the invention is characterized in that the element having diode functionality is connected in series with an LR-circuit, which LR-circuit is connected to the discharge electrode. As a result, an activation signal consisting of a DC high voltage component comprising a superposed AC high voltage component is delivered on the discharge electrode in an adequate and simple manner, wherein more particularly the induction value L of the LR-circuit is adjustable. More in particular, the impedance value L ranges between 1 nH and 1000 mH.

The LR-circuit may be series-connected or parallel-connected.

In a specific, functional embodiment, the high voltage source is an AC/DC pulse converter, and in another embodiment the high voltage source is more particularly an AC/DC/AC converter.

The invention will now be explained in more detail with reference to a drawing, in which:

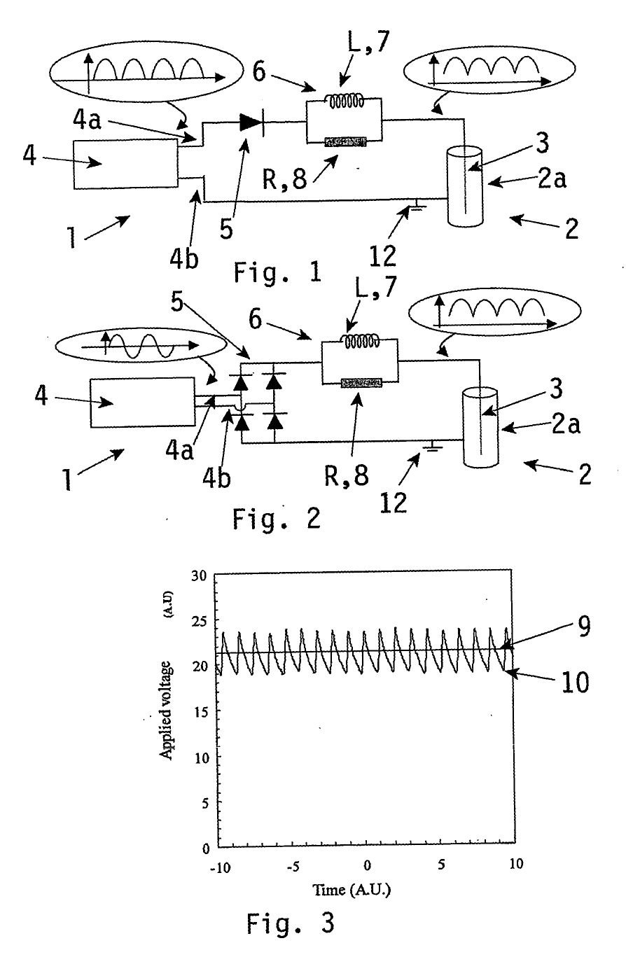

FIG. 1 shows a first embodiment of an apparatus according to the invention;

FIG. 2 shows another embodiment of an apparatus according to the invention;

FIG. 3 shows an example of the discharge voltage applied to the discharge electrode, plotted against time;

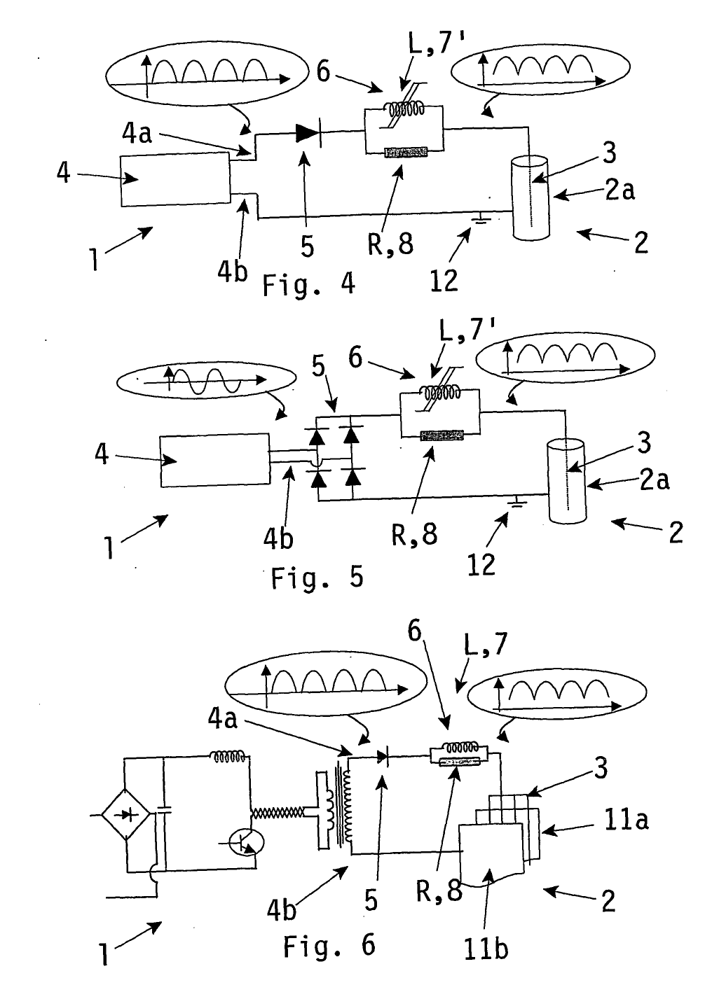

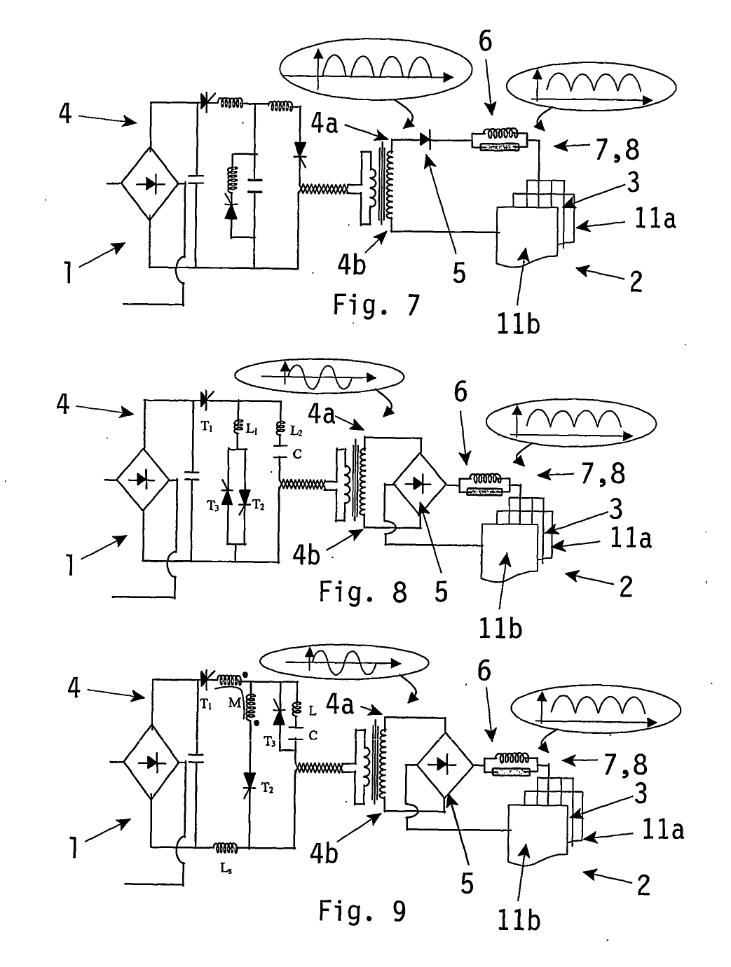

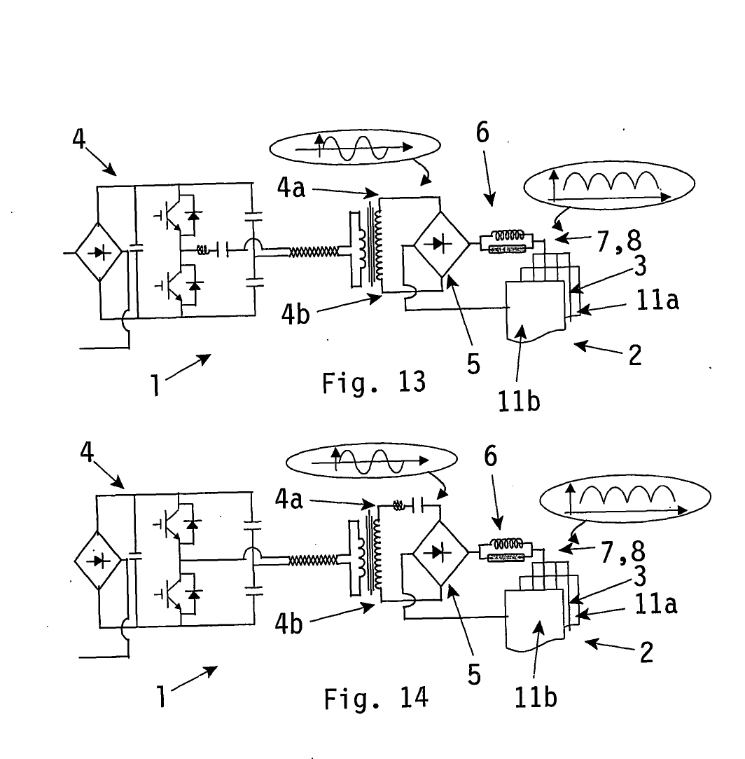

FIGS. 4-14 show further embodiments of an apparatus according to the invention;

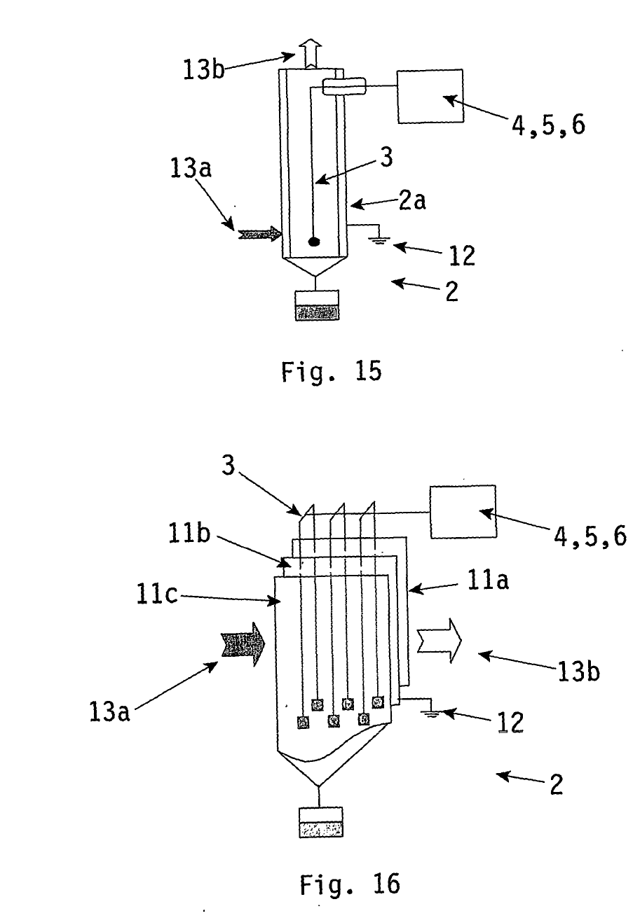

FIGS. 15 and 16 show two embodiments of a corona discharge space for use in an apparatus according to the invention; and

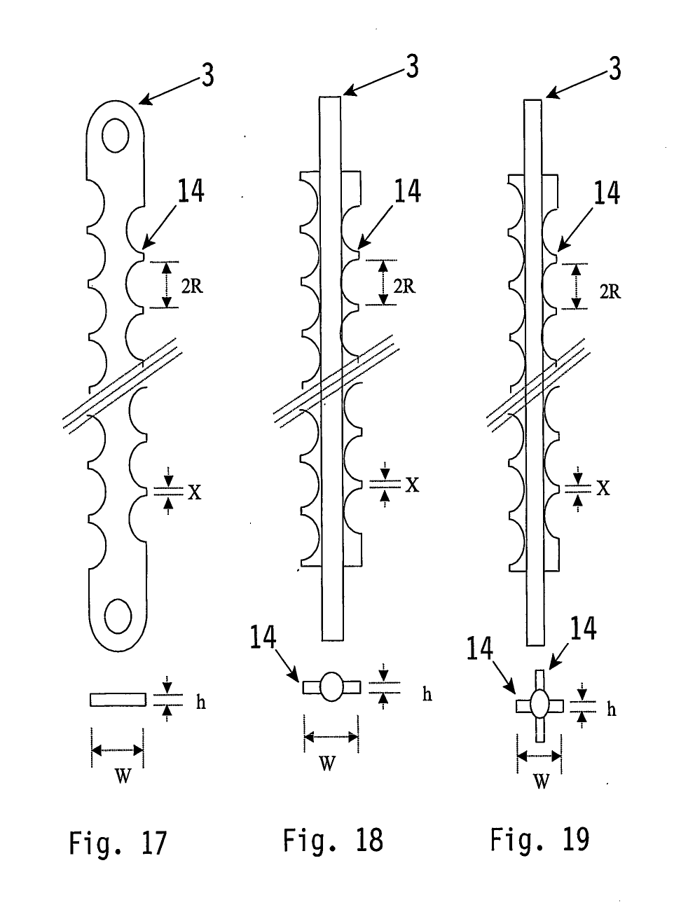

FIGS. 17-19 show three embodiments of a discharge electrode for use in an apparatus according to the invention.

For a clear understanding of the invention, like parts will be indicated with the same numerals in the description of the figures below.

In FIG. 1, a first embodiment of an apparatus for generating corona discharges according to the invention is shown. The apparatus 1 comprises a corona discharge space 2, which is built up of a discharge electrode 3 that is housed in a metal casing, which is connected to the earth potential 12. The apparatus 1 furthermore comprises a high voltage source 4, which delivers a high voltage via its two output terminals 4a and 4b, and an element 5 having diode functionality, which is in turn connected to the discharge electrode 3 via an LR-circuit 6.

The element 5 having diode functionality is connected in the apparatus in such a manner that the AC voltage signal applied to the output terminals 4a and 4b by the high voltage source 4 will have the waveform that is shown in the enlarged left-hand detail view in FIG. 1. Since the AC voltage signal is superposed on a DC voltage signal, the element 5 having diode functionality, in combination with the LR-circuit 6, ensures that a voltage signal having the waveform that is shown in the right-hand detail view and in FIG. 3 is applied to the discharge electrode 3.

The voltage signal that is plotted against time in FIG. 3 comprises a DC component 9 and an AC component 10. The letters A.U. stand for “Arbitrary Unit”.

In specific embodiments, the element 5 having diode functionality may be a semiconductor element, which is configured as a rectifier, a transistor, a diode or a thyristor, for example.

In the embodiment that is shown in FIG. 1, the element 5 having diode functionality is configured as a single-phase rectifier, in contrast to the embodiment that is shown in FIG. 2, in which the element 5 having diode functionality is built up of several rectifiers and functions as a bridge rectifier. The AC signal presented to the bridge circuit 5 via the output terminals 4a and 4b of the high voltage source 4 is converted by the bridge rectifier 5 into a signal as shown in the enlarged in detail view of FIG. 2.

FIGS. 4 and 5 disclose embodiments which are substantially the same as the embodiments of FIGS. 1 and 2. In these embodiments, however, the induction value L of the inductance 7′ of the LR-circuit is adjustable. More specifically, the inductance value L of the inductance 7-7′ is 1 nH-1000 mH.

Other embodiments of the apparatus according to the invention are shown in FIGS. 6-14.

In order to obtain an optimum operation of the apparatus for generating corona discharges according to the invention, the DC high voltage component has a value of 1-60 kV, more in particular 6-35 kV. The AC high voltage component that is superposed on the DC voltage component may have a frequency of 0.1-100 kHz, more in particular 5-30 kHz.

In a specific embodiment as shown in FIGS. 6-14 and FIG. 16, the discharge electrode 3 is an elongate body provided with several projecting edges.

Specific embodiments thereof are disclosed in FIGS. 17-19. In these embodiments, the discharge electrode is an elongate body 3, which body may be an elongate strip in FIG. 17. Several projecting edges or cams 14 have been formed on this strip by means of a punching operation. The spacing 2R between successive cams is 1-100 mm, whilst the width X of each cam is 0-100 mm.

The thickness h of the strip is 0.1-10 mm, and the thickness W of the strip is 2-500 mm.

In FIGS. 18 and 19, the discharge electrode 3 is an elongate bar with projecting cams 14 extending on either side of the electrode present thereon.

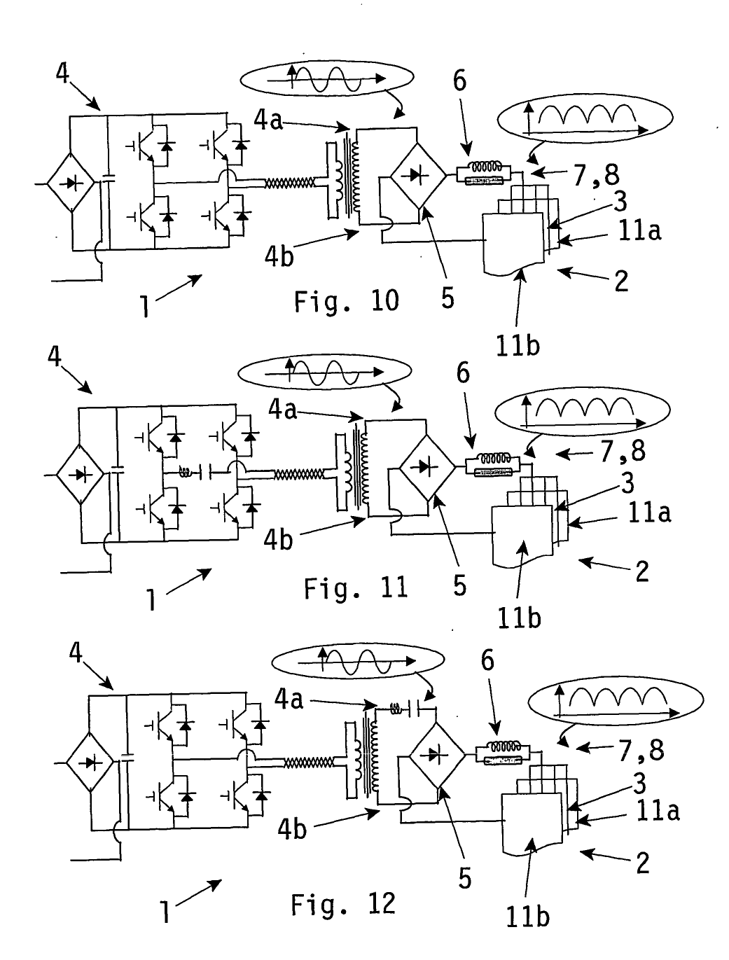

FIG. 9 shows an embodiment that is derived therefrom, with the cams projecting in four directions from the discharge electrode 3.

The corona discharge space 2 may be built up of two or more parallel, electrically earthed plates 11a-11b-11c . . . (refer in particular to FIG. 16), between which plates 11a-11b-11c- . . . the discharge electrode 3 extends in parallel relationship therewith. This construction of the corona discharge space 2, makes it possible to generate positive “streamer” corona discharges in the corona discharge space 2 through the application of a high-voltage signal to the discharge electrode 3, as is shown in FIG. 3, which corona discharges are very suitable for treating gases and/or liquids and/or surfaces and/or aerosols.

Specific applications for treating gases and/or liquids and/or surfaces and/or aerosols in an apparatus according to the invention are shown in FIGS. 15 and 16. In these embodiments, the gases and/or liquids and/or surfaces and/or aerosols are introduced into the corona discharge space 2 via an inlet 13a, in which space 2 said gases and/or liquids and/or surfaces and/or aerosols are subjected to the positive “streamer” corona plasma that is being generated. The treated gases and/or liquids and/or surfaces and/or aerosols exit the corona discharge space 2 via the outlet 13b. The flow may also take place via the outlet 13b (now functioning as the inlet) to the inlet 13a (now functioning as the outlet).

Positive “streamer” corona discharges can in particular be generated in the discharge space 2 because the high voltage source 4 is an AC/DC pulse converter as shown in the embodiment of FIGS. 1 and 4a, whilst on the other hand the high voltage source 4 may be an AC/DC/AC converter as shown in the embodiment of FIGS. 2 and 4b.

With an AC/DC pulse converter, a circuit that converts voltage pulses having the same polarity into high-power, high-voltage signals is fed from the mains or from another continuous supply source, usually a rectifier.

With an AC/DC/AC converter, a circuit that converts alternately positive and negative (AC) voltage pulses into high-power, high-voltage signals is fed from the mains or from another continuous supply source, usually a rectifier.

Although the LR-circuit is configured as a parallel circuit in the illustrated embodiment, a series-connected LR-circuit may also be very suitable for operating the apparatus according to the invention if the correct inductance L and resistance R are selected.

1. An apparatus for generating corona discharges, comprising
a corona discharge space;
a discharge electrode disposed in the corona discharge space; as well as
a high voltage source, an output of which is connected to the discharge electrode, wherein at least one element having diode functionality is connected between the high voltage source and the discharge electrode, which element delivers a DC high voltage component comprising a superposed AC high voltage component on the discharge electrode.

2. An apparatus according to claim 1, wherein the element having diode functionality is a semiconductor, which is configured as a rectifier, a transistor, a diode or a thyristor, for example.

3. An apparatus according to claim 1 or 2, wherein the element having diode functionality is configured as a single-phase rectifier.

4. An apparatus according to claim 1 or 2, wherein the element having diode functionality is configured as a bridge rectifier.

5. An apparatus according to claim 1, wherein the DC high voltage is 10-60 kV.

6. An apparatus according to claim 1, wherein the frequency of the AC high voltage is 0.1-100 kHz.

7. An apparatus according to claim 1, wherein the discharge electrode is an elongated body having several projecting edges or cams.

8. An apparatus according to claim 7, wherein said projecting edges extend on either side of said body.

9. An apparatus according to claim 1, wherein the corona discharge space is built up of at least two parallel, electrically earthed plates, between which plates the discharge electrode extends in parallel relationship therewith.

10. An apparatus according to claim 1, wherein the element having diode functionality is connected in series with an LR-circuit, which LR-circuit is connected to the discharge electrode.

11. An apparatus according to claim 10, wherein the induction value L of the LR-circuit is adjustable.

12. An apparatus according to claim 10 or 11, wherein said inductance value ranges between 1 nH and 1000 mH.

13. An apparatus according to claim 1, wherein the high voltage source is an AC/DC pulse converter.

14. An apparatus according to claim 1, wherein the high voltage source is an AC/DC/AC converter.

15. A discharge electrode for use in an apparatus according to claim 1 and as defined in claim 7 or 8.

16. An apparatus according to claim 5, wherein the DC high voltage is 5-35 kV.

17. An apparatus according to claim 6, wherein the frequency of the AC high voltage is 5-30 kHz.
